(19) United States
(12) Patent Application Publication
(10) Pub. No.: US 2026/0081183 A1
(43) Pub. Date: Mar. 19, 2026

(54) Non-Woven Pitch-Based Carbon Fiber Electrodes for Low-Cost Redox Flow Battery

(71) Applicant: Clemson University, Clemson, SC (US)

(72) Inventors: Abena A. Williams, Clemson, SC (US); Sagar V. Kanhere, Clemson, SC (US); Amod A. Ogale, Clemson, SC (US); Mark E. Roberts, Clemson, SC (US)

(21) Appl. No.: 19/330,412

(22) Filed: Sep. 16, 2025

Related U.S. Application Data
(60) Provisional application No. 63/695,515, filed on Sep. 17, 2024.

(51) Int. Cl. H01M 4/86; H01M 4/88; H01M 4/90; H01M 8/18

(52) U.S. Cl. CPC H01M 4/8615; H01M 4/8875; H01M 4/8878; H01M 4/9083; H01M 8/188

(57) ABSTRACT

An improved redox flow battery, and method of making a redox flow battery, are described. The redox flow battery comprising a positive electrode tank comprising a catholyte and a cathode electrode and a negative electrode tank comprising an anolyte and an anode electrode. A membrane is between the positive electrode tank and the negative electrode tank wherein at least one of the cathode electrode or the anode electrode is a pitch-based carbon fiber electrode.

### CROSS-REFERENCE TO RELATED APPLICATIONS

This application claims priority to pending U.S. Provisional Ser. No. 63/695,515 filed Sep. 17, 2024 which is incorporated herein by reference.

### FIELD OF THE INVENTION

The present invention is related to an improved redox flow battery and, more specifically, to a non-woven pitch-based carbon fiber electrode and redox flow battery comprising the electrode.

### BACKGROUND

With increasing global energy demands and goals to reduce our dependence on carbon emitting fuels, electricity generation from renewable sources, such as wind and solar, has seen tremendous growth over the past two decades. Because of the intermittent nature of these sources, it is necessary to develop low-cost Long Duration Energy Storage (LDES) systems to support their integration into the electric grid and maintain stability. Alternatively, LDES systems can be deployed as stand-alone electricity storage sources. The current solution to address the variable energy supply is the use of natural gas powered generators; however, this backup system, while extremely reliable, is very expensive and contributes to greenhouse gas emissions.

Other emission-free options, such as Pumped-Storage Hydropower stations, cause significant environmental damage and are not feasible at different scales. Energy storage systems must be efficient, safe, and cost-effective for sustainable energy transition to be considered options for long-duration energy storage of renewable sources. Current commercial options for LDES include Pumped-Storage Hydropower (PSH) and Compressed Air Energy Storage (CAES), both of which depend on geographical forms, and are hard to deploy on grid-scale applications.

Redox flow batteries (RFBs) are an emerging energy storage technology that is unique from other types of batteries because the power and energy outputs are decoupled.

Charge is stored in electrolytes comprising active ion species contained in external tanks wherein the electrolytes are pumped through porous carbon electrodes where charging/discharging occurs. The energy is dependent upon the size of the tanks and the concentration of the ions, while the power is governed by the size of the electrode stack and the properties of the electrode. The state-of-the-art RFB uses vanadium in the electrolytes, a Nafion™ membrane, and polyacrylonitrile (PAN) derived carbon felt electrodes. While effective, the cost exceeds that which is considered necessary to achieve widespread commercial success.

There has been extensive research focused on reducing the cost of RFBs. Most of the research has focused on developing alternative, lower-cost membranes or new electrolytes based on abundant redox materials, such as iron or zinc, with limited attention given to the electrode material. Electrode materials also contribute significantly to GHG emissions among all components of RFBs, second to electrolytes.

Provided herein is an improved electrode which contributes to improvements in the functionality and cost of RFBs.

### SUMMARY OF THE INVENTION

The present invention is related to an improved electrode for a redox flow battery.

More specifically, the present invention is related to a non-woven pitch-based carbon fiber electrode for use in a redox flow battery.

A particular feature of the invention is the ability to decrease cost of redox flow batteries, particularly, the cost of the electrode.

Another feature is the ability to utilize pitch as in the formation of an electrode for a redox flow battery.

These and other advantages, as will be realized, are provided in a redox flow battery comprising a positive electrode tank comprising a catholyte and a cathode electrode and a negative electrode tank comprising an anolyte and an anode electrode. A membrane is between the positive electrode tank and the negative electrode tank wherein at least one of the cathode electrode or the anode electrode is a pitch-based carbon fiber electrode.

Yet another advantage is provided in a method of forming a redox flow battery comprising:
forming a porous non-woven electrode from pitch;
providing a cathode electrode tank comprising a catholyte and a cathode electrode;
providing an anode electrode tank comprising an anolyte and an anode electrode;
placing a membrane between the positive electrode tank and said negative electrode tank; and
wherein at least one of the cathode electrode or the anode electrode is the porous non-woven electrode.

### BRIEF DESCRIPTION OF DRAWINGS

FIG. 1 is a schematic representation of a redox flow battery.

FIG. 2 is a schematic representation of a melt-blow processing apparatus.

FIG. 3 is a scanning electron micrograph illustrating an advantage of the instant invention.

FIGS. 4A and 4B are graphical representations illustrating the advantages of the instant invention.

FIGS. 5A and 5B are graphical representations illustrating the advantages of the instant invention.

FIGS. 6A-6F are graphical representations illustrating the advantages of the instant invention.

FIGS. 7A-7F are graphical representations illustrating the advantages of the instant invention.

### DESCRIPTION

The present invention is related to a low-cost non-woven carbon fiber (NWCF) electrode derived from petroleum pitch and produced using a scalable and inexpensive melt-blowing process. Compared to commercial PAN-derived carbon fiber felt, pitch-based NWCFs have increased graphitic content, tensile strength, and electrical conductivity at a fraction of the cost. RFBs fabricated with oxidized NWCF electrodes show nearly identical battery performance to those prepared with commercial PAN felts in vanadium electrolytes. When RFBs with NWCF electrodes are evaluated in a zinc iodide electrolyte, the voltage and power density are acceptable. RFBs with NWCF using an iron-based electrolyte are contemplated as being suitable for use as well. Because the precursor and processing methods are both inexpensive relative to PAN-based fibers, NWCF electrodes offer a promising solution to minimizing the cost of RFB electrode material. Furthermore, with the optimization of carbon fiber synthesis and surface treatment, these materials are expected to lead to improved battery performance.

Redox reflow batteries and their construction is well known in the art and, other than the inventive components described herein are not necessarily altered.

The invention will be described with reference to the figures forming an integral, non-limiting, component of the disclosure.

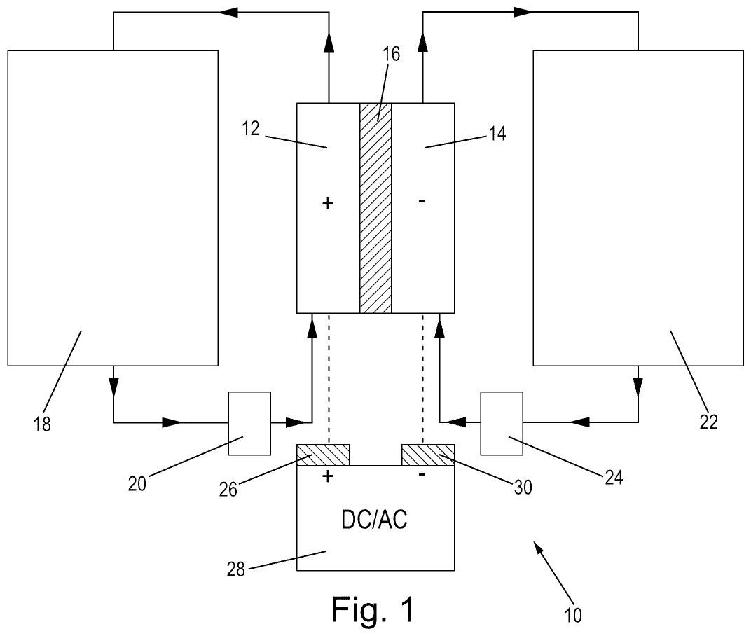

A redox flow battery, or RFB, is illustrated schematically in FIG. 1. The RFB, 10, comprises a cathode electrode, 12, and anode electrode, 14, separated by a membrane, 16. In the present invention the electrode, which can function as the cathode electrode or anode electrode, is improved. The membrane separates the anode from the cathode as understood in the art. A positive electrode tank, 18, contains a charged catholyte that has a relatively positive electrochemical potential which is circulated through the cathode of the RFB by a cathode pump, 20. A negative electrolyte tank, 22, contains a charged anolyte that has a relatively negative electrochemical potential which is circulated through the anode by an anode pump, 24. The cathode is in electrical contact with the source cathode, 26, of an energy source, 28, and the anode is in electrical contact with a source anode, 30, of the energy source. During the discharge phase of the reaction the electrolytes are pumped out of the tanks and through the electrodes thereby allowing for the discharged electrons to be released in the form of electricity when an energy demand requires. Flowing electrons that continue through the electrode core and are returned back to the electrolyte tanks represent the charging phase of the reaction.

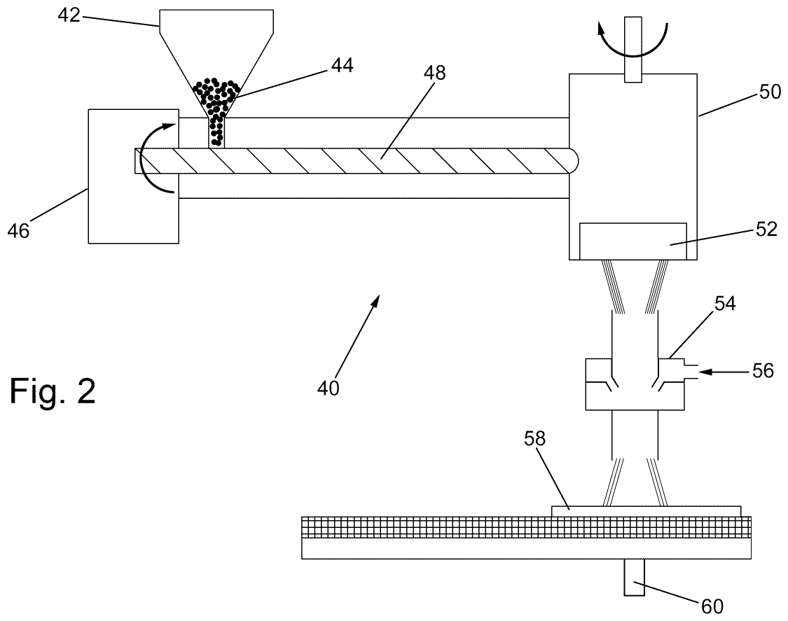

A schematic representation of a melt-blowing apparatus is illustrated in cross-sectional view in FIG. 2. In FIG. 2, the melt-blowing apparatus, 40, comprises a hopper, 42, which feeds pitch pellets, 44, into an extruder pump, 46. The extruder screw, 48, extrudes the pellets into a metering pump, 50, and through a spinneret, 52, into an air impingment device, 54, wherein air, 56, flows into contact with the extruded material. The melt blown fibers, 58, are subjected to vacuum from a vacuum port, 60.

When NWCF electrodes are evaluated in zinc iodide electrolytes, the voltage and power density (83 mW cm⁻²) are slightly lower compared to RFBs with PAN-derived carbon felts (104 mW cm⁻²) @ 100 mA/cm² prior to implementation of NWCF electrodes optimized for the instant invention. RFBs fabricated with oxidized low-cost NWCF electrodes show nearly identical battery performance to those prepared with commercial PAN-derived carbon felts in vanadium electrolytes with a peak power density of 137 mW cm−2 vs. 139 mW cm−2, respectively. Because of their low-cost precursor and cheaper processing methods, NWCF electrodes offer a promising solution to reducing the cost of RFB electrode materials in terms of cost and battery performance.

Electrode materials for RFBs must be electrochemically and mechanically stable, conductive, and wettable by the electrolyte to facilitate the charge-transfer reactions at the solid-liquid interface. Carbon in the form of nanofibers in a felt or cloth is inert, relatively low-cost and conductive compared to other alternatives; however, they are expensive to produce and can lead to high pressure drop across the felt. Commercial PAN-based carbon electrodes are prepared by conventional textile nonwoven methods such as needle punching; however, the fibers are made using either roll spinning or electrospinning, both of which require solvents and a coagulation bath. The electrospinning method, however, is difficult to scale up and requires additives to the polymer solution. About half of the cost of carbon filament comes from the cost of the precursor itself, and since PAN is an expensive precursor, lower-cost alternatives have been investigated. Rayon-based carbon felts have received attention, but they are limited by a low carbon yield of 25% compared to 40% for PAN, relatively low conductivity, and higher overall fiber cost. Furthermore, Rayon-based carbon fibers are more susceptible to oxidation than PAN-based carbon at high state of charge. Lignin-based carbon electrodes are proposed as an alternative, but they are just in the research phase and are yet to be commercialized. Because carbon fiber electrodes are generally hydrophobic, electrodes are often oxidized or pretreated to improve their wettability and electrochemical activity.

Inventive carbon fibers are preferably made from mesophase pitch, which is a low-cost precursor that is leftover as a byproduct from petroleum refining and is widely available and underutilized. With costs projected to be less than $2/lb and carbon yields as high as 80%, pitch-based carbon fibers are an excellent alternative for PAN-based carbon electrodes. They are also shown to have a lower environmental impact than their PAN-based carbon fiber alternatives. Additionally, their highly oriented graphitic microstructure gives rise to excellent thermal and electrical conductivity. As compared with PAN-derived carbon fibers, mesophase pitch-based carbon fibers possess three times higher electrical conductivity and double the modulus. As a result, pitch-based carbon fibers are generally used for high stiffness reinforcement carbon fibers or thermal management and only some work has been reported as electrode material for Li-ion batteries. Unlike PAN or rayon, pitch-based precursor fibers can be produced using melt-blowing, a low-cost and scalable process that can produce non-woven carbon fiber mats. This is possible because mesophase pitch-based fibers form their microstructural orientation during the fiber spinning step, and it is retained during stabilization and carbonization step. Additionally, from a sustainability standpoint, the pitch-based carbon fibers have estimated to generate up to 68% lower greenhouse gas emissions than PAN-based carbon fibers due to least processing involved to produced precursor pitch.

Non-woven pitch-based fiber mats were produced using the melt-blowing method which is well known in the art. The pitch, containing about 75 wt % mesophase content, was extruded using 2.56 cm (1 inch) diameter single-screw extruder operating continuously through a proprietary design of spinnerets. The exiting fibers were pulled through an air aspirator at 10-15 psig that was held about 5.08-7.6 cm (2-3 inches) below the spinnerets and collected on a mesh substrate connected to the vacuum. The fibers we stabilized in a forced air convection ove;, provided buy Memmert GmbH+Co, Schwabach, Germany; and carbonized at about 2100°C. in an Astro 1000 furnace provided by Thermal Technology, LLC.

The electrical resistance (R) of single fibers was measured by first mounting single filaments on paper tabs that were then placed between two copper wires separated by 10 mm. Using this known length and area, calculated from measured diameters of the fiber, electrical resistivity was calculated. Tensile analysis of carbon fibers was based on the ASTM D3379-75 standard test procedure. A single fiber was mounted on a paper tab with a 10 mm gauge length and bonded to the tab using epoxy resin. After curing of epoxy resin the sides of the tab were burned away within the grips of a MTI Phoenix testing machine and the fiber was stressed to failure at a constant strain rate of 0.5 mm/min. Cross-sectional area of the fiber was determined by measuring the diameter of individual filaments using an Olympus BX60 optical microscope.

To analyze the cross-sectional microstructure and longitudinal surface of the carbon fibers, scanning electron microscopy was conducted on samples using high-resolution FESEM scopes which was a S4800/SU5000 by Hitachi. For Raman analysis, individual filaments were scanned under Renishaw inVia Raman microscope with a laser wavelength of 785 nm and laser power of 25 mW. The incident beam was focused on fiber surface using 50× objective lens. The collected spectra were analyzed using WiRE Raman Software version 3.4. A silicon standard with Raman shift at 520 cm−1 was used to calibrate the detector. Wide-Angle X-ray Diffraction analysis was conducted using a Rigaku SmartLab Powder Diffractometer with Cu Kα radiation source having a 0.15406 nm wavelength and Hypix3000 detector. The location of the 2 θ peaks was calibrated using NIST Silicon standard.

Cyclic voltammetry experiments were conducted in a three-electrode cell using VersaStat 4 provided by VersaStudio, Princeton Applied Research. Ag/AgCl was used as the reference electrode, a graphite rod was used as the counter electrode, and a glassy carbon electrode (GCE) from BASi, BASi MF 2012, was used as the working electrode. The vanadium electrolyte was 1.0 M vanadium (IV) sulfate oxide hydrate, from BeanTown Chemicals, in 3.0 M sulfuric acid from Fisher Scientific. Vanadium (IV) was converted to Vanadium (III) by charging at 1.8 V until the current decreased below 10 mA. The zinc iodine electrolyte contained 1.0 M potassium iodide, from Acros Organics, and 0.5 M zinc bromide, from ThermoFisher Scientific, in a solution comprising 1.0 M potassium chloride from Sigma Aldrich.

Lab-scale redox flow batteries from ElectroCell were assembled with a 10 cm² electrode area. All electrical tests were conducted on an Arbin Instruments MSTAT21044 battery analyzer, and a multi-head peristaltic pump from Chonry was used to circulate electrolytes through the cells. The electrode materials were either non-woven carbon fiber (NWCF) mats or PAN-based GFE-1 specialty felt carbon felts from Ceramaterials. The Pan-based mats were previously soaked in redox electrolyte overnight. For comparison to pretreated PAN felts, NWCF electrodes were oxidized using potassium-permanganate from Fisher Scientific oxidized at 80° C.

For the V RFB, a 178 μm Nafion™ 117 membrane was used with 50 mL of electrolyte in each tank. The membrane was activated by refluxing at 90° C. for 1 h each with DI water, 3 v % hydrogen peroxide used as provided from Fisher, DI water, 0.5 M sulfuric acid, using 98% from Fisher, DI water, and 3 M sulfuric acid. The membrane was stored in 3M sulfuric acid until use. VOSO₄ (V⁴⁺) was used as both catholyte and anolyte. The battery was charged at 50 mA cm⁻² until 1.8 V, then charged at 1.8 V until the current decreased below 10 mA wherein the catholyte was converted to V⁵⁺ and the anolyte was converted to V³⁺. The catholyte (V⁵⁺) was replaced with the original VOSO₄ (V⁴⁺) solution and the battery was charged again to convert the catholyte to V⁵⁺ and the anolyte to V²⁺. N₂ gas was bubbled through both tanks to prevent the oxidation of vanadium ions. Polarization curves were developed on the fully charged battery at a current less than 10 mA at 1.8 V by discharging the battery for 30 s time periods from low to high current densities with a 30 s rest period between each current density. Charge discharge tests were done at varying current densities by charging to 1.8V for low current densities of 15 and 20 mA cm⁻² and 1.85V for high current densities at 30, 35, and 40 mA cm⁻², then discharging to 0.8 V. Cycling tests were performed by first charging the battery partially at a current density of 10 mA cm⁻² to a voltage of 1.8 V, and the repeated charge discharge at a current density of 20 mA cm⁻² with limits of 1.8 and 0.8 V for charge and discharge, respectively.

For the ZI RFB, Nafion™ 212 (50 μm) was used as the membrane, and 125 mL of electrolyte was used in each tank. The membrane was activated by refluxing at 90° C. for 1 h each with DI water, 3 v % hydrogen peroxide, DI water, 0.5 M sulfuric acid, DI water, and 1 M potassium chloride from Alfa Aesar. The activated membrane was stored in 1 M potassium chloride until use. Battery conditioning was performed by charging for 0.1 Ah and then discharging to 0.8 V at current densities of 10, 20 and 40 mA cm⁻². Polarization curves were developed as described above on a fully charged battery by applying 10 mA cm⁻² to 1.5 V. For charge-discharge tests, upper voltage limits were 1.65 V for current densities of 35 and 30 mA cm⁻², 1.6 V for 25 and 20 mA cm⁻² and 1.5 V for 10 mA cm⁻². The discharge limit for all current densities was 0.8 V. Long-term cycling was performed at 25 mA cm⁻² with limits of charge discharge voltage 1.55V and 0.8V.

Inventive carbon fiber electrodes were produced from mesophase pitch, with at least 50% mesophase content, more preferably at least 60 mesophase pitch and no more than 80% mesophase content, using a melt-blowing process to create low-cost electrode materials for redox flow batteries. Fibers were drawn to a target diameter using the melt-blowing apparatus shown schematic in FIG. 2. Mesophase pitch fiber mats were collected on a mesh that was connected to vacuum suction. These fibers were then stabilized at 220°C. and carbonized at 2100°C., resulting in a carbon fiber non-woven felt. Because the fibers can be continuously blown into non-woven mat, this process is highly scalable, and NWCF felts as large as about 15×10 cm (6×4 inches) have been produced. Furthermore, no additional solvents or coagulation baths are required, and the fibers do not need to be stretched to obtain highly graphitic content.

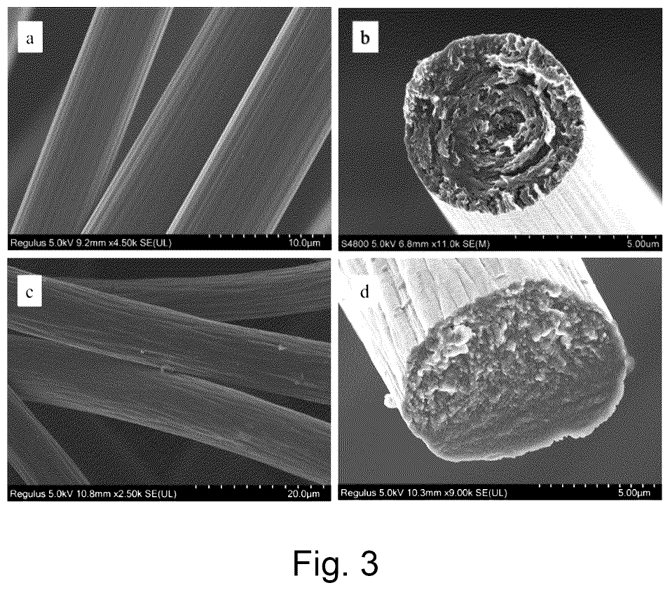

The tensile and electrical properties of carbon fibers prepared from mesophase pitch were evaluated and compared with fibers from commercial PAN-based felts. Scanning electron microscopy (SEM) images of fiber surfaces and cross-sections are shown in FIG. 3 for mesophase pitch-based fibers (a and b) and PAN-based fibers (c and d), respectively. The diameter of carbon fibers from the NWCF electrodes is 7.1±0.7 μm, whereas that of PAN-based fibers is 10±1 μm. Thus, without any surface activation to create micropores, the smaller diameter fibers result in a moderately higher surface area per mass, which is advantageous for the liquid-to-solid electrochemical reactions. As evident from the SEM images, PAN-based carbon fibers, from within the felt, show granular carbon structure, whereas pitch-based fibers, from within the NWCF mat, show highly ordered graphitic development with graphitic edges directed towards the lateral surface. The graphitic edge plane orientation observed in the NWCFs is desired because sites on edge planes are generally considered to be more electrochemically active.

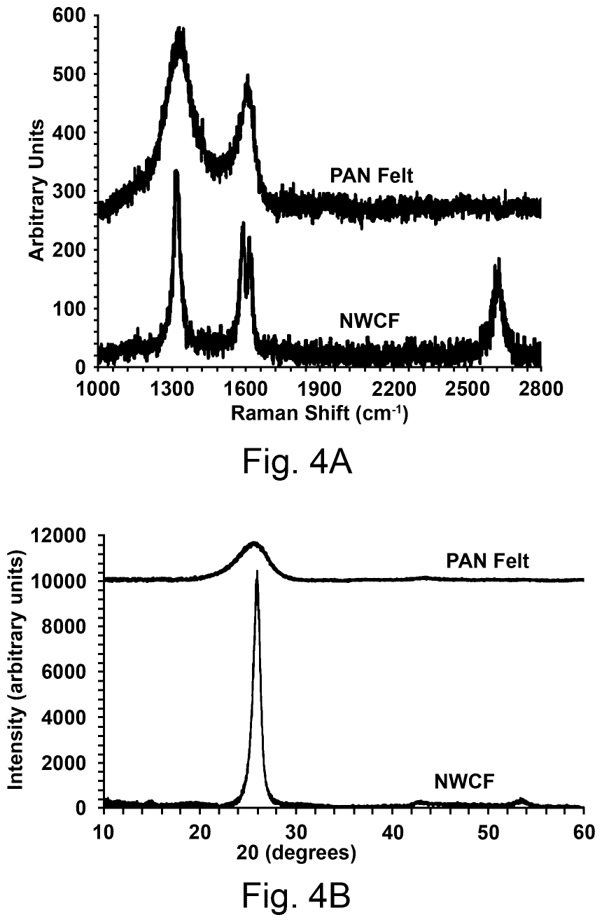

The graphitic structure of carbon within the fibers from each electrode type was determined using Raman spectroscopy, which can measure the relative amount of graphitic like SP2 vs diamond like SP3 carbon in a given material. FIG. 4A shows the resultant Raman spectra of PAN-derived carbon felt and NWCF electrodes. As evidenced by the more pronounced G and D peaks, along with the presence of G′ and D′ peaks, carbon within the NWCF electrodes exhibit a more ordered, graphitic structure compared to carbon from the PAN-derived carbon felt. The IG/ID ratio, which is the ratio of the area under the G and D peaks, respectively, is a quantitative indicator graphitic content. The carbon within the NWCF fibers had a substantially higher IG/ID ratio of 0.6±0.1 compared to that from PAN-derived carbon, 0.3±0.1, which confirms the increased graphitic content observed in the SEM images.

Wide angle X-ray diffraction (WAXRD) was also used to evaluate the graphitic structure within the bulk material. As shown in FIG. 4B, NWCF electrodes exhibited a sharp two-theta peak centered at 25.9°, whereas for PAN-derived carbon felt showed a broad peak around 25.4°. The interlayer spacing (d002) is calculated using Bragg's law, yielding a value of 0.35 nm for PAN-derived carbon felt fibers and 0.34 nm for NWCF fibers. Using the Scherrer equation, it is estimated that the NWCF electrodes have a layer stacking height (Lc) of 4 nm, which is double that of the PAN-derived felt fibers (2 nm). Thus, WAXRD analysis further confirms that NWCF electrodes possess a notably higher organized graphitic structure than PAN-derived carbon felt fibers, consistent with Raman analysis.

Carbon fiber electrodes for redox flow batteries need to be durable to maintain structural integrity under cell compression and flow conditions and conductive to deliver current flow to and from the electrolyte. The tensile strength of carbon fibers within the commercial PAN-derived carbon felt were found to be 0.6±0.3 GPa with a corresponding tensile modulus of 100 GPa. In contrast, the untreated NWCF carbon fibers had a notably higher tensile strength of 2.2±0.7 GPa, but this decreased slightly to 1.5±0.7 GPa after surface oxidation, while the tensile modulus remained around 250 GPa. In a preferred embodiment the tensile strength of the NWCF is at least 1.3 GPa to no more than 2.5 GPa. Because of the improved mechanical properties, there is no concern for physical or mechanical degradation of the NWCF electrodes within a flow cell. Next, electrical resistivity of individual filaments of fibers from PAN-derived carbon felts and NWCF mats were measured using a 2 pt probe method. Carbon fibers from the PAN-derived carbon felt had a baseline electrical resistivity of 15±3μΩ. m. Fibers from the NWCF mat, on the other hand, had a significantly lower electrical resistivity of 8±1μΩ. m, which was expected because of their increased order and graphitic content relative to PAN-derived carbon felt. In a preferred embodiment the electrical resistivity of the NWCF is at least 4 μΩ. m no more than 10 μΩ. m. Thus, NWCF fibers exhibit improved mechanical and electrical properties compared to PAN-derived carbon felts, making them viable candidates for flow battery electrodes.

The characterization of NWCF versus PAN clearly indicate that the inventive NWCF material is distinguishable as evidenced by optical observation, Raman spectroscopy, and x-ray diffraction analysis.

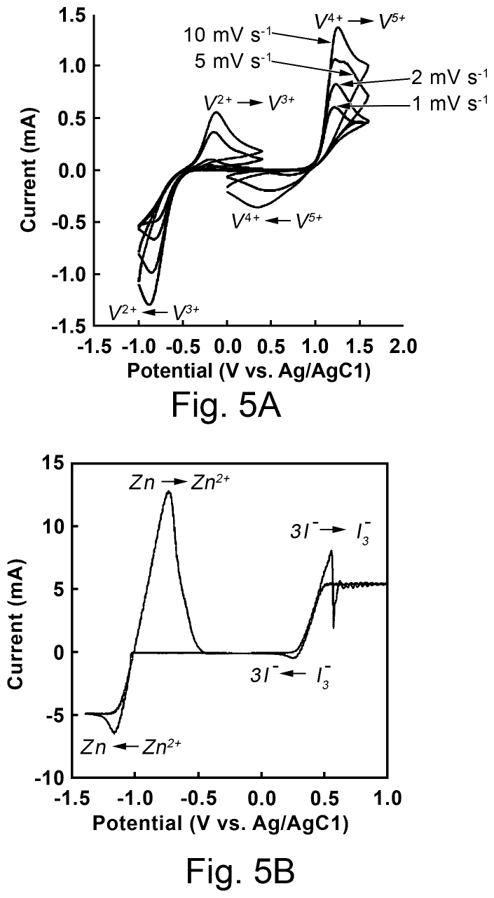

Electrodes comprising NWCFs were evaluated in redox flow batteries using both conventional vanadium (V) and conventional zinc iodine (ZI) electrolytes and compared with RFBs assembled with PAN-derived carbon felt electrodes. Prior to battery testing, the redox behavior of the electrolytes was established using a three-electrode cell with a glassy carbon (GC) working electrode, an Ag/AgCl reference and graphite rod counter electrode. FIG. 5A shows the cyclic voltammetry profiles at various scan rates in the vanadium electrolyte, with the anolyte in the negative potential range and the catholyte in the positive. As the voltage is decreased from 0 V vs Ag/AgCl in the anolyte, V³⁺ is reduced to V²⁺ below −0.5 V, and then V²⁺ oxidized back to V³⁺ when the potential is increased back to 0. On the catholyte side, V⁴⁺ is oxidized to V⁵⁺ as the potential is increased above 0.9 V and then V⁵⁺ converts back to V⁴⁺ when the potential is reduced back to 0. Both sets of curves show excellent reversibility and stability, along with the expected linear increase in peak current with increasing scan rate, which is comparable to CV profiles performed on other carbon materials.

The redox behavior of the zinc iodine electrolyte is shown in FIG. 5B on the same GC electrode at a scan rate of 10 mV s⁻¹. Because the ZI system is symmetric, the same electrolyte is used for the catholyte and the anolyte, the cell was scanned over the combined potential range. The reversible oxidation of 3I⁻ to I₃^{-¿¿} occurs when the potential is increased above 0.4 V vs. Ag/AgCl and Zn²⁺ is reduced Zn metal as the potential is decreased below −1.0 V, similar to previously reported results for ZI electrolytes on GC electrodes. The Zn/Zn²⁺ redox couple on the anolyte side exhibits low reversibility because of the zinc plating/stripping reactions occurring on the electrode, as evidenced by the asymmetric redox couple.

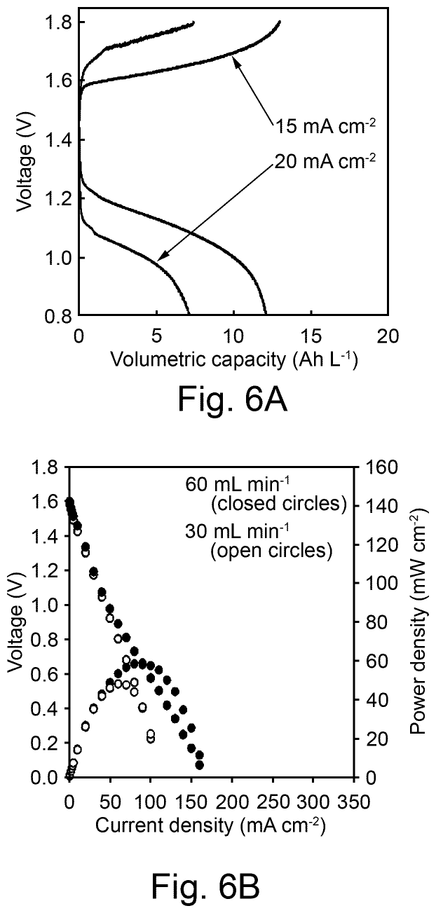

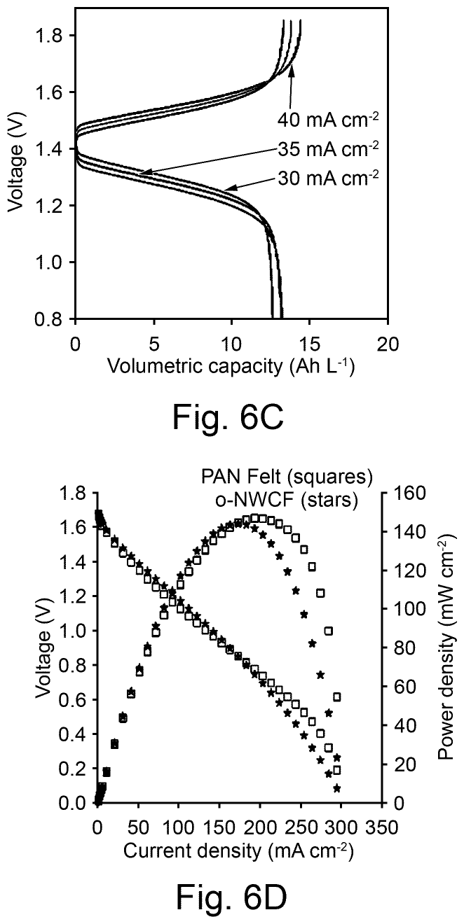

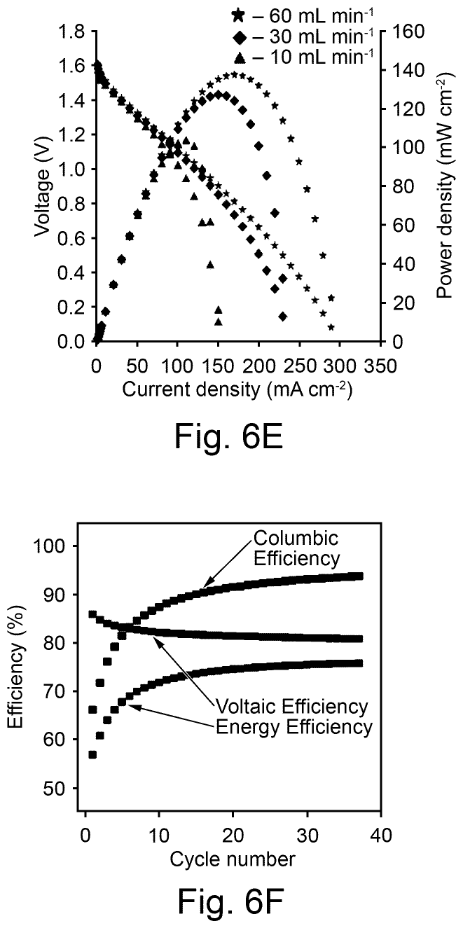

The performance of as synthesized NWCF electrodes in redox flow batteries was initially evaluated in lab-scale test cells prior to any surface oxidation or treatment. RFBs assembled with Vanadium redox chemistry were equipped with a Nafion™117 membrane and 50 mL electrolyte tanks. FIG. 6A shows the charge-discharge characteristics of RFBs with untreated NWCF electrodes with electrolyte circulating at a rate of 60 mL min⁻¹. The ordinate axis is normalized to volumetric capacity (Ah L⁻¹) by multiplying discharge time by current and dividing by tank volume. Because the electrolyte tank capacity is constant, the discharge curves would intercept this axis at the same value in the absence of any voltage losses or diffusion limitations. However, a large overpotential is observed at current densities as low as 15 mA cm⁻² resulting in a relatively low discharge voltage. The decrease in voltage is severe even at only moderately higher potentials, presumably due to the unoptimized electrode surface chemistry.

Polarization curves were developed on fully charged RFBs by measuring the discharge voltage with increasing current density until the discharge voltage reached 0. At each current density, beginning with 0.5 mA cm⁻², the batteries were discharged for 30 s followed by a 30 s rest period between applied currents. The discharge voltage is reported as the average voltage over the discharge period. Power density, obtained from Ohm's law (P=I*V), is the product of the discharge current density and voltage. FIG. 6B shows the polarization curves for RFBs with untreated NWCF electrodes with electrolytes circulating at rates of 30 and 60 mL min⁻¹. As expected, higher flow rates resulted in higher discharge voltages because more active redox species is available in a single pass through the electrodes. Regardless of the flow rate, discharge voltages were generally low, and the cells were unable to sustain high current densities. RFBs with untreated NWCF electrodes had a peak power density of 59 mW cm⁻² at 90 mA cm⁻², which is well below that obtained from RFBs with commercial PAN-derived carbon felt electrodes which are ˜139 mW cm⁻² at 190 mA cm⁻².

While typical losses arise from the ohmic resistance of the membrane and electrode resistance, here the performance is clearly limited by the electrode surface because all other components of the cell are identical. It's worth noting that the untreated NWCF electrodes visually appeared hydrophobic and had to be soaked overnight to become saturated with electrolytes prior to use in the RFB. Furthermore, RFBs with as-synthesized NWCF required extensive charge-discharge conditioning to achieve stable performance. Thus, untreated NWCF electrodes are likely insufficient for redox flow batteries using vanadium redox chemistry. However, commercial PAN-derived carbon felt electrodes have undergone extensive optimization of their surface treatment and activation to improve their interaction with the vanadium electrolyte.

The surface of carbon fiber-based electrodes for Vanadium redox flow batteries can be modified using various surface treatments, from chemical or thermal oxidation to vary surface chemistry, or activation to vary surface area and structure. To provide a more relevant comparison to surface-activated PAN-derived carbon felt electrodes, the NWCF electrodes were oxidized using a previously reported chemical oxidation method with potassium permanganate. Treatment of carbon fibers with KMnO₄ resulted in higher amounts of oxygen on the electrode surface, which is known to increase the rate of reaction due to increased wettability and number of reaction sites. Accordingly, the oxygen content of NWCF electrodes increased from (1.3±0.2)% to (4.3±0.8)% after treatment with KMnO₄ without any observable difference in surface structure (via SEM).

FIG. 6C shows the charge-discharge characteristics of KMnO4-treated NWCF electrodes charged to 1.8 V and discharged to 0.8 V for current densities of 30-40 mA cm⁻². The ordinate axis is normalized to volumetric capacity as described above, which is approximately 13 Ah L⁻¹ regardless of the discharge current. Only slight decreases in discharge voltage were observed with increasing current density due to ohmic losses. Relative to RBFs with untreated NWCF electrodes, the voltage efficiency was significantly improved due to decreased overpotential. This is attributed to the fact that chemical oxidation improves the wettability of the electrode, thus increasing electrolyte uptake and utilization, and likely increases the number of reaction sites, and therefore reaction rate, at the electrode surface. Improved electrolyte contact and higher charge transfer rates are evident by the decrease in overpotential even at moderately high current density.

Polarization curves were developed on fully charged RFBs with KMnO4-treated NWCF electrodes in a similar manner as those with untreated materials. FIG. 6D shows the polarization curves for these RFBs with electrolyte flow rates between 10 and 60 mL min⁻¹. The voltages reported are not IR-corrected because the difference was not significant. As expected from improvements observed in charge-discharge behavior, RFBs with treated electrodes exhibited significantly higher discharge voltages and could sustain higher currents than cells with untreated electrodes. Surprisingly, there was a negligible effect of flow rate on discharge voltage for current densities below 100 mA cm⁻² because the surface treatment eliminated reaction limitations under these conditions. An increase in discharge voltage is observed with increasing flow rates, which is typical for flow batteries, because the electrolyte channels are replenished with active redox species at rates necessary to support the current demand. The peak power density of 137 mW cm⁻² at 170 mA cm⁻² obtained represents a 132% increase compared to cells with untreated NWCF electrodes exhibiting 59 mW cm⁻² at 90 mA cm⁻². This significant difference highlights the importance of surface properties on RFB performance, and the need to properly activate NWCF electrodes.

Redox flow batteries with PAN-derived carbon felt electrodes were prepared, controlling all other aspects of the cell, for comparison with the batteries comprising NWCF electrodes. FIG. 6E shows the polarization curves for cells with each electrode material using an electrolyte flow rate of 60 mL min⁻¹. While the discharge voltage and power density look very similar for both batteries, some notable differences are present. First, the peak power density of the RFB with PAN-derived carbon felt of 139 mW cm⁻² is slightly higher than those with NWCF of 137 mW cm⁻². However, the higher performance with PAN-derived carbon felt is only realized for extremely high current densities where the discharge voltage is prohibitively low for commercial operation such as <0.8 V. In fact, for current densities up to ˜150 mA cm⁻², RFBs with NWCF electrodes outperform those with PAN-derived carbon felt. These results highlight the fact that a new class of carbon fiber electrodes derived from a very low cost petroleum pitch precursor offers a suitable substitute to the conventional PAN-based electrode system to help drive down the cost of RFBs. As PAN-derived carbon felt electrodes have undergone substantial optimization to improve their performance in RFBs, we expect ongoing research on surface activation to further improve the performance of NWCF electrodes.

The stability of vanadium RFBs with NWCF electrodes was evaluated through continuous charge-discharge cycling at 20 mA cm⁻² and 60 mL min⁻¹ over 23 hours/37 cycles charged to 1.8V and discharge to 0.8V. For each cycle, the columbic, voltaic and energy efficiency were calculated and plotted, as shown in FIG. 6F. The voltage efficiency slightly decreased over the first few cycles while the coulombic efficiency increased, which is in part due to the state of the battery before cycling with the battery being charged at a higher current than cycling. After the initial break-in, or conditioning phase, the performance of the battery remained stable over 20 h or ˜35 cycles with no indication of impending degradation.

To reduce the cost of the RFB associated with the electrolyte, alternative redox chemistries have been studied as a replacements to vanadium. This includes iron and zinc-based electrolytes mainly because of their low cost, high solubility, environmental friendliness, and natural abundance. As opposed to vanadium-based electrolytes that are highly acidic, these systems are often based on alkali or neutral salts. Therefore, NWCF electrodes were also evaluated in a neutral zinc based electrolyte that varies in many ways from the vanadium system. RFBs were assembled using a symmetric zinc iodide electrolyte, using the same anolyte and catholyte, with Nafion™ 212 membranes, as described elsewhere. In a similar manner as described above, RFBs with untreated NWCF electrodes were evaluated over a range of conditions and compared to batteries with KMnO₄ treated NWCF electrodes and commercial PAN-derived carbon felt electrodes.

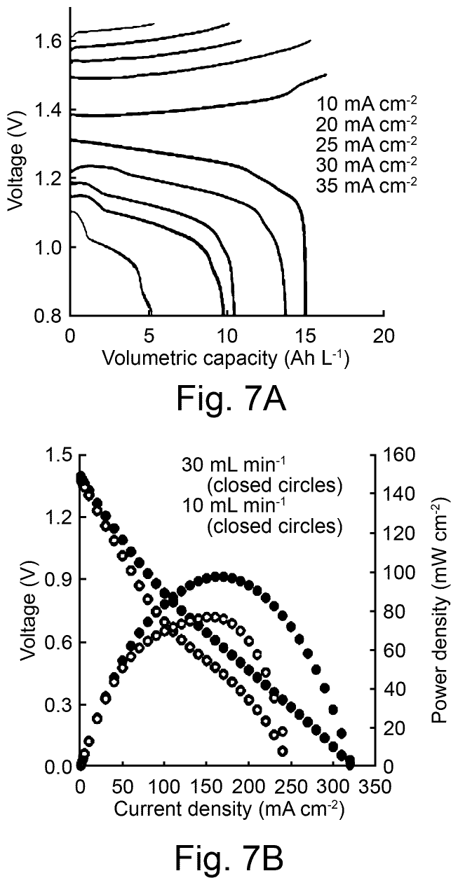

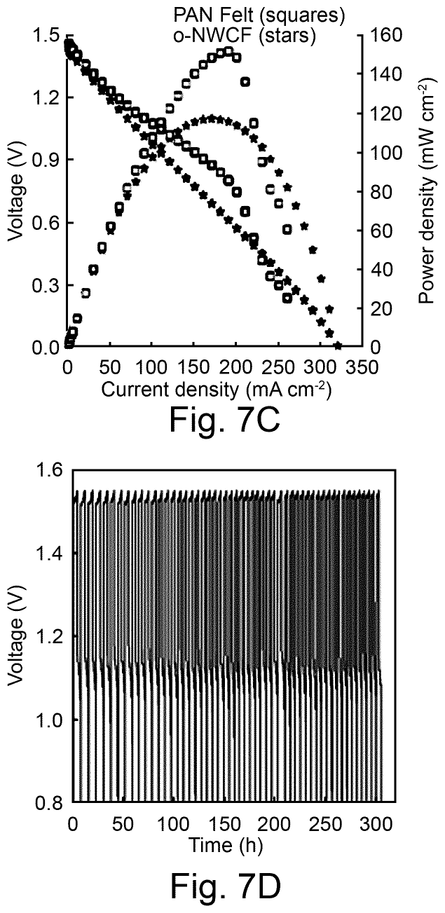

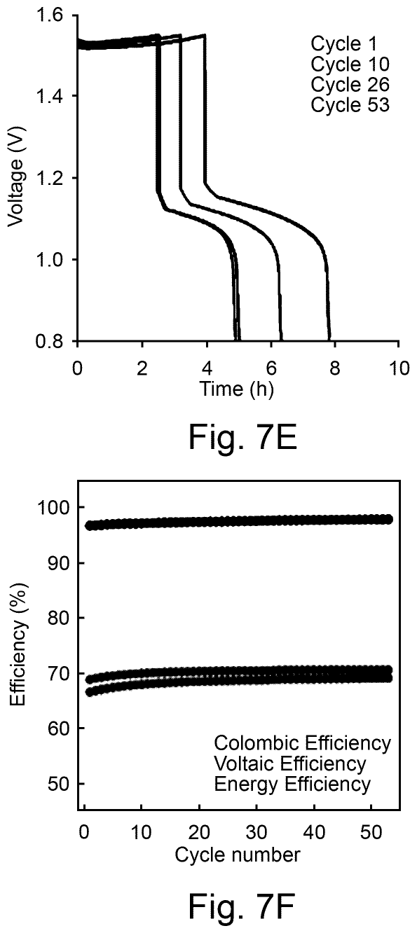

FIGS. 7A-7F shows the performance of RFBs assembled with the various electrodes in the ZI electrolyte. Galvanostatic charge-discharge cycling of the RFB with untreated NWCF electrodes is shown in FIG. 7A with an electrolyte flow rate of 30 mL min−1 for a range of current densities. For these cycles, the discharge voltage was limited to 0.8 V and the charge was limited to 1.65 V for current densities of 35 and 30 mA cm⁻², 1.6V for 25 and 20 mA cm⁻² and 1.5V for 10 mA cm⁻² to avoid high voltages and oxygen generation from the water-splitting reaction at the anode. As the current density is increased, the discharge voltage, cycle time and the overall capacity decrease because of the higher overpotential, activation resistance and increased ohmic resistance. At the highest current density, the discharge curve becomes distorted because of zinc plating on the anode, which reduces the amount of electrode active surface available for further reaction.

Polarization curves were created at flowrates of 10 and 30 mL min⁻¹ to investigate each battery's response to higher current loads and correspondingly higher ion-transfer demands. Before discharging, the battery was charged to at 1.5 V at 10 mA cm⁻². FIG. 7B shows the results of the polarization analysis for the RFB with untreated NWCF electrodes, which includes the discharge voltage vs current density for various electrolyte flow rates, and the power density vs current density. The voltages reported are not IR-corrected because the difference was not significant. As expected, higher discharge voltages, and therefore power density, were achieved with increasing flowrate. In the ZI electrolyte, RFBs with untreated NWCF electrodes had a peak power density of 98 mW cm⁻² which was much higher than RFBs with untreated NWCF in vanadium, which is well below that obtained from RFBs with commercial PAN-derived carbon felts of ˜145 mW cm⁻².

FIG. 7C shows the polarization curves for RFBs with KMnO₄ treated NWCF and PAN-derived carbon felt electrodes. Compared to RFBs with untreated NWCF electrodes, those with oxidized NWCF showed a 16% improvement in power density, but this is still low relative to the peak power observed in RFBs with PAN-derived carbon felt. While the improvement in battery performance is relatively small, untreated NWCF already performs well in the ZI electrolyte, especially at current densities up to 100 mA cm⁻². Although PAN-based felts had higher voltages and power densities there was a significant drop in the voltage profile due to excessive amount of zinc plating and dendrite formation. While this is inferior to RFBs with PAN-derived carbon electrodes, we have only been able to perform a single surface treatment, and it's likely the electrode surface requires specific treatment depending on redox electrolyte formulation. One benefit of the untreated NWCF electrodes is the reduction of zinc plating and dendrite formation during battery operation. Selective treatment of electrodes for the anode and cathode could provide a path to improved battery performance, in terms of power and stability, using low-cost pitch-based electrode materials.

The cycling stability was assessed by continuously charging and discharging the RFBs with NWCF electrodes at 25 mA cm⁻² and a flowrate of 60 mL min⁻¹ for over 300 h (53+ cycles), as shown in FIG. 7D. For clarity, the initial, intermediate and final cycles are shown in FIG. 7E. Some capacity fading is observed up to about 20 cycles and 130 hours due to zinc plating, but it is worth noting that the capacity remains fairly constant for all subsequent cycles. Furthermore, coulombic, voltage, and energy efficiency all remain steady after the initial few cycles, as shown in FIG. 6F.

Low-cost and sustainable non-woven carbon fiber electrodes, produced from mesophase petroleum-pitch precursor using a scalable melt-blowing process, can perform comparable to benchmark PAN-based electrode materials of redox flow batteries, if not slightly better under typical operating conditions. The development of new electrode materials is often overlooked because the majority of studies to reduce the cost of RFBs are focused on electrolytes and membranes, the two main cost factors in flow batteries. The electrode materials still make up 12% of the overall flow battery cost and compared to PAN-derived carbon felt electrodes, petroleum pitch-based carbon fiber electrodes can be produced at a fraction of the cost.

Compared to commercial PAN-derived carbon fibers, pitch-based carbon fibers have increased graphitic content, tensile strength, and electrical conductivity. RFBs fabricated with oxidized NWCF electrodes show nearly identical battery performance to those prepared with commercial PAN-derived carbon felts in vanadium electrolytes exhibiting a peak power density of 137 mW cm⁻² vs. 139 mW cm⁻², respectively. Carbon fiber electrodes derived from mesophase pitch even outperform those derived from PAN at current densities below 150 mA cm⁻². When RFBs with NWCF electrodes are evaluated in a zinc iodide electrolyte, the voltage and power density of 83 mW cm⁻² are slightly lower compared to RFBs with PAN-derived carbon felts which are 104 mW cm⁻²@100 mA/cm². Because of their low-cost precursor and processing methods, NWCF electrodes offer a promising solution to minimizing the cost of RFB electrode materials, and with further optimization, these electrodes will likely result in improved battery performance.

The invention has been described with reference to preferred embodiments without limit thereto. One of skill in the art would realize additional embodiments which are described and set forth in the claims appended hereto

1. A redox flow battery comprising:
a positive electrode tank comprising a catholyte and a cathode electrode;
a negative electrode tank comprising an anolyte and an anode electrode;
a membrane between said positive electrode tank and said negative electrode tank; and
wherein at least one of said cathode electrode or said anode electrode is a pitch-based carbon fiber electrode.

2. The redox flow battery of claim 1 wherein said catholyte comprises at least one metal selected from the group consisting of vanadium, iron and zinc.

3. The redox flow battery of claim 1 wherein said anolyte comprises at least one metal selected from the group consisting of vanadium, iron and zinc.

4. The redox flow battery of claim 1 wherein said pitch-based carbon fiber electrode is porous.

5. The redox flow battery of claim 1 wherein said pitch-based carbon fiber electrode is oxidized.

6. The redox flow battery of claim 1 wherein said pitch-based carbon fiber electrode is carbonized.

7. The redox flow battery of claim 1 wherein a Raman spectra of said pitch-based carbon fiber electrode exhibits at least one peak selected from G′ or D′.

8. The redox flow battery of claim 1 wherein said pitch-based carbon fiber electrode comprises ordered graphitic edges directed towards a lateral surface.

9. The redox flow battery of claim 1 wherein said pitch-based carbon fiber electrode has a tensile strength of at least 1.3 GPa to no more than 2.5 GPa.

10. The redox flow battery of claim 1 wherein said pitch-based carbon fiber electrode has an electrical resistivity of at least 4 μΩ. m no more than 10 μΩ. m.

11. A method of forming a redox flow battery comprising:
forming a porous non-woven electrode from pitch;
providing a cathode electrode tank comprising a catholyte and a cathode electrode;
providing an anode electrode tank comprising an anolyte and an anode electrode;
placing a membrane between said positive electrode tank and said negative electrode tank; and
wherein at least one of said cathode electrode or said anode electrode is said porous non-woven electrode.

12. The method for forming a redox flow battery of claim 11 wherein said pitch comprises meso phase pitch.

13. The method for forming a redox flow battery of claim 11 wherein said pitch comprises at least 50 wt % meso phase pitch.

14. The method for forming a redox flow battery of claim 13 wherein said pitch comprises at least 60 wt % meso phase pitch.

15. The method for forming a redox flow battery of claim 13 wherein said pitch comprises no more than 80 wt % meso phase pitch.

16. The method for forming a redox flow battery of claim 11 wherein said forming comprises melt blowing.

17. The method for forming a redox flow battery of claim 11 further comprising oxidizing said non-woven electrode.

18. The method for forming a redox flow battery of claim 11 further comprising carbonizing said non-woven electrode.

19. The method for forming a redox flow battery of claim 11 wherein said catholyte comprises at least one metal selected from the group consisting of vanadium, iron and zinc.

20. The method for forming a redox flow battery of claim 11 wherein said anolyte comprises at least one metal selected from the group consisting of vanadium, iron and zinc.

21. The method for forming a redox flow battery of claim 11 wherein a Raman spectra of said pitch-based carbon fiber electrode exhibits at least one peak selected from G′ or D′.

22. The method for forming a redox flow battery of claim 11 wherein said pitch-based carbon fiber electrode comprises ordered graphitic edges directed towards a lateral surface

23. The rnethod for forming a flow redox flow battery of claim 11 wherein said pitch-based carbon fiber electrode has a tensile strength of at least 1.3 GPa to no more than 2.5 GPa.

24. The rnethod for forming a redox flow battery of claim 11 wherein said pitch-based carbon fiber electrode has an electrical resistivity of at least 4 μΩ. m no more than 10 μΩ. m.
